(19) United States
(12) Patent Application Publication
(10) Pub. No.: US 2005/0035340 A1
(43) Pub. Date: Feb. 17, 2005

(54) Protective railing mounting arrangement

(76) Inventors: Donald R. Otte, New Berlin, WI (US); Thomas J. Bella JR., Stevens Point, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/915,020

(22) Filed: Aug. 10, 2004

Related U.S. Application Data
(60) Provisional application No. 60/494,964, filed on Aug. 14, 2003.

(51) Int. Cl. A01K 3/00

(52) U.S. Cl. 256/13.1

(57) ABSTRACT

A guardrail mounting arrangement comprises a support post having a face surface including a plurality of receiving slots formed therein. The receiving slots are aligned in a pair of spaced columns. At least one mounting bracket has a pair of side walls, each including a series of depending ears. Each of the ears are sized to be received in one of the receiving slots formed on the support post. The pair of side walls define an open interior. A guardrail section extends between a first end and a second end. The first end of the guardrail section is sized to receive within the mounting bracket such that the mounting bracket supports the first end of the guardrail section along the support post.

### CROSS-REFERENCE TO RELATED APPLICATION

This application claims priority to U.S. Provisional Patent Application No. 60/494,964, filed Aug. 14, 2003.

### BACKGROUND OF THE INVENTION

The present invention generally relates to a guardrail system. More specifically, the present invention relates to a guardrail system that includes mounting brackets that are removably mounted to a support post and each receive a section of the guardrail.

Presently, guardrail systems are formed from a series of guardrail sections that are securely mounted between spaced support posts. Typically, each guardrail section includes a corrugated, elongated body that includes an attachment plate welded to each of its ends. The welded attachment plate includes a series of holes that allow the attachment plate to be securely attached to a support post. Such a system is available as the Steel Guard product available from Steel King Industries of Stevens Point, Wisconsin.

A drawback of the system described is the inability of the system to be easily configured and the length of the guardrails to be modified without requiring additional welding and complex metal working. An additional drawback is the inability of the system to be easily assembled and disassembled on-site. Rather, the system described is static or permanent in nature and typically only facilitates long-term use. Therefore, a need exists for a modular guardrail mounting arrangement that allows the length of the guardrails to be modified without requiring additional metal working steps. A need also exists for a guardrail system that allows for quick and easy on-site assembly and disassembly.

### SUMMARY OF THE INVENTION

The present invention relates to such a modular guardrail mounting system that allows for quick and easy on-site assembly and disassembly and that facilitates long term use. In a preferred embodiment, the guardrail mounting arrangement comprises a support post having a face surface including a plurality of receiving slots. The receiving slots are aligned in a pair of spaced columns. At least one mounting bracket has a pair of sidewalls, each including a series of depending ears. Each of the ears is sized to be received in one of the receiving slots formed on the support post. The pair of sidewalls define an open interior. A guardrail section extends between a first end and a second end. The first end of the guardrail section is sized to receive the mounting bracket such that the mounting bracket supports the first end of the guardrail section along the support post.

### BRIEF DESCRIPTION OF THE DRAWINGS

The drawings illustrate the best mode contemplated of carrying out the invention.

In the drawings:

FIG. 1 is a perspective view illustrating the guardrail mounting system of the present invention;

FIG. 2 is a side view of the mounting bracket that forms part of the mounting arrangement;

FIG. 3 is an end view of the mounting bracket shown in FIG. 2;

FIG. 4 is a top plan view of the stamped steel section that forms the mounting bracket of FIGS. 2 and 3;

FIG. 5 is an end view of the support post including the plurality of the aligned mounting slots;

FIG. 6 is an end view of the corrugated guardrail; and

FIG. 7 is a front view of the corrugated guardrail.

### DETAILED DESCRIPTION OF THE PREFERRED EMBODIMENTS

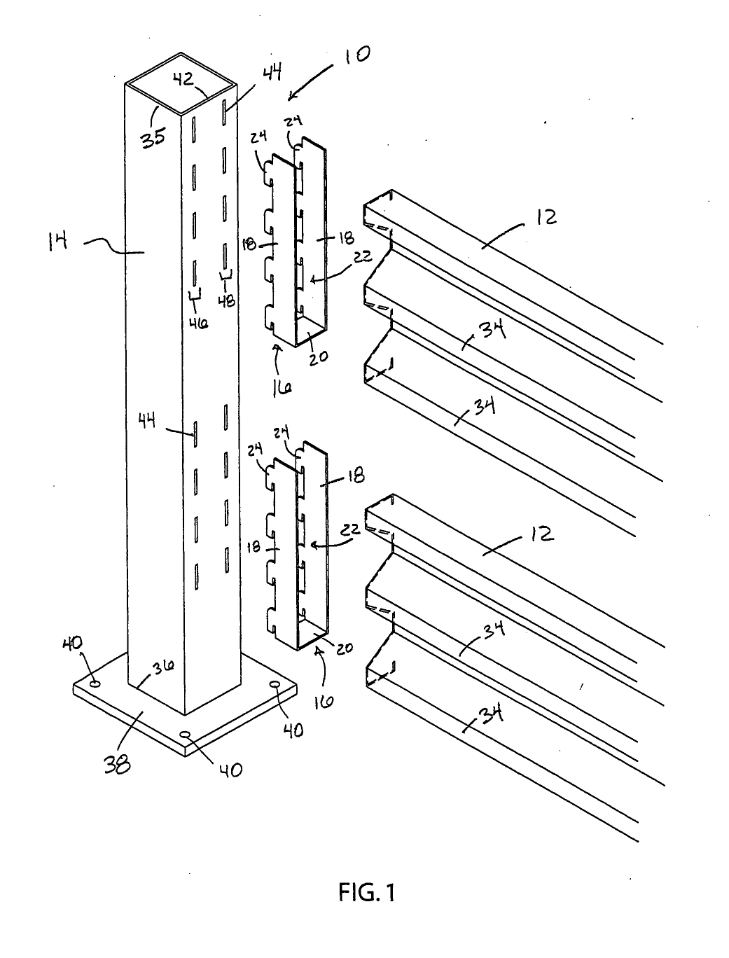

Referring first to FIG. 1, thereshown is a unique mounting arrangement 10 of the present invention. The mounting arrangement 10 generally provides a point of secure connection between a guardrail section 12 and a support post 14. The mounting arrangement of the present invention allows the end of the guardrail sections 12 to be supported along the support post 14 such that the guardrail sections can be securely and easily mounted to the support posts 14.

The mounting arrangement 10 of the present invention includes a mounting bracket 16 for supporting each of the guardrail sections 12. In the embodiment of the invention illustrated in FIG. 1, a pair of mounting brackets 16 are shown for supporting a pair of spaced guardrail sections 12. Although a pair of guardrail sections 12 are shown in FIG. 1, it should be understood that a single guardrail section could be used while operating within the scope of the present invention.

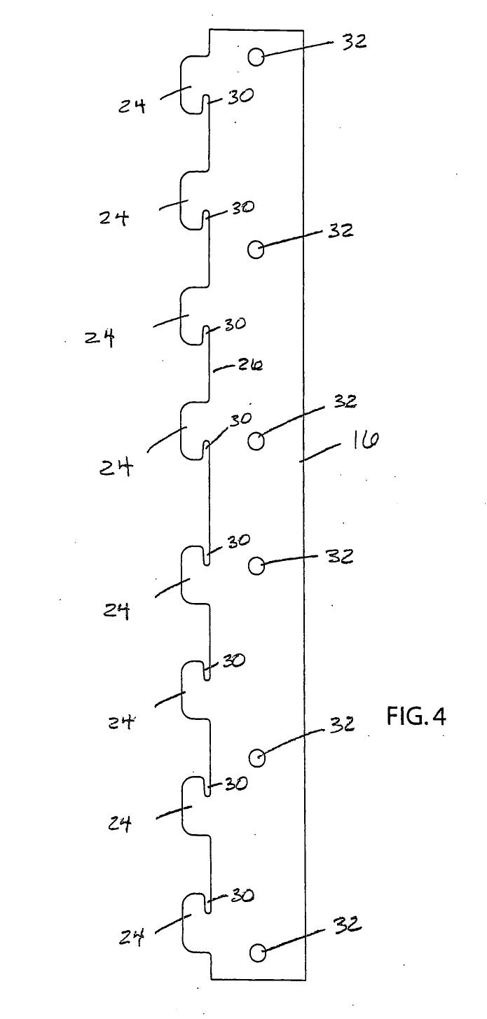

Each of the mounting brackets 16 includes a pair of spaced sidewalls 18 joined to each other by a bottom wall 20. Preferably, each of the mounting brackets 16 is formed from a single piece of stamped steel as shown in FIG. 4. The single piece of stamped steel is bent into the U-shaped configuration shown in FIG. 1 such that the mounting bracket 16 defines an open receiving area 22. Preferably, the open receiving area 22 is sized to receive the guardrail section 12 such that the guardrail can be supported by the mounting bracket 16.

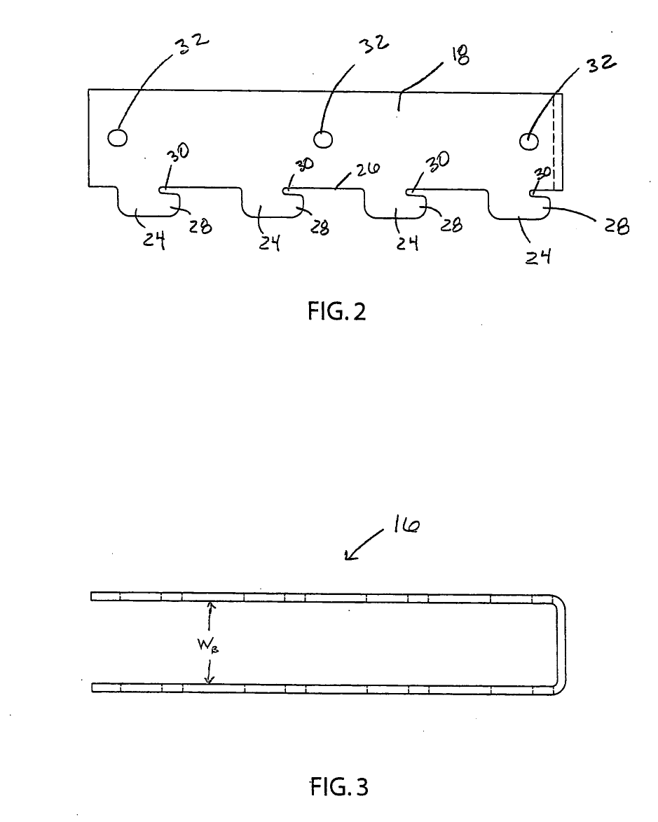

Referring now to FIG. 2, each of the sidewalls 18 of the mounting bracket 16 includes a plurality of ears 24 that protrude from the back edge 26 of the sidewall 18. Each of the ears 24 includes a lower, depending section 28 that defines a receiving slot 30. Each sidewall 18 includes a plurality of holes 32 that each receives a clevis pin (not shown). The clevis pin pass through the holes 32 and engage one of the flat face surfaces 34 formed on the guardrail section 12, as shown in FIG. 1.

Referring back to FIG. 1, the support post 14 extends between an upper end 35 and a base end 36. The base end 36 includes a support platform 38 having a plurality of holes 40 that receive attachment bolts to hold the support posts 14 securely in place. As can be seen in FIG. 1, the support post 14 has a generally rectangular cross-section and includes a face surface 42. The face surface 42 includes a plurality of slots 44. The slots 44 are aligned in four rows and defined two parallel columns 46 and 48. The parallel columns 46, 48 are spaced such that the columns receive the plurality of ears 24 formed on the sidewalls 18 of the mounting bracket 16.

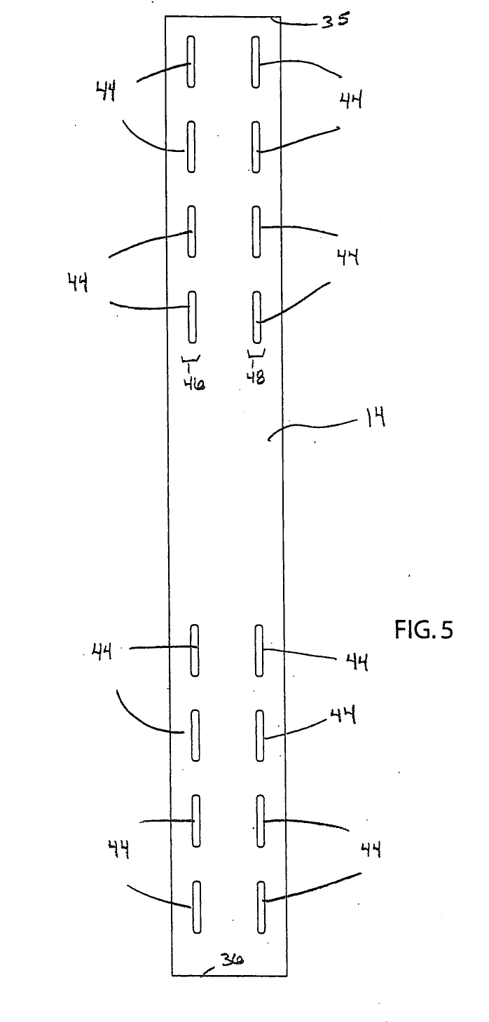

Referring now to FIG. 5, each of the slots 44 in the preferred embodiment of the invention has a length of approximately 2¼ inches. The slots 44 are thus sized to receive each of the ears 24, which have a length of 1⅞ inches, as illustrated in FIG. 4. As can be understood in FIG. 1, each of the ears 24 is inserted into one of the slots 44 and the mounting bracket 16 is moved downward until the wall defining the face surface 42 is received within the slots 30 defined between the ears 24 and the wall 26, as shown in FIG. 2. Once the mounting bracket is secured to the support post 14, the guardrail section 12 is inserted into the channel 22 and a series of connectors, typically, clevis pins (not shown), pass through the holes 32 to more securely hold the guardrail section in place.

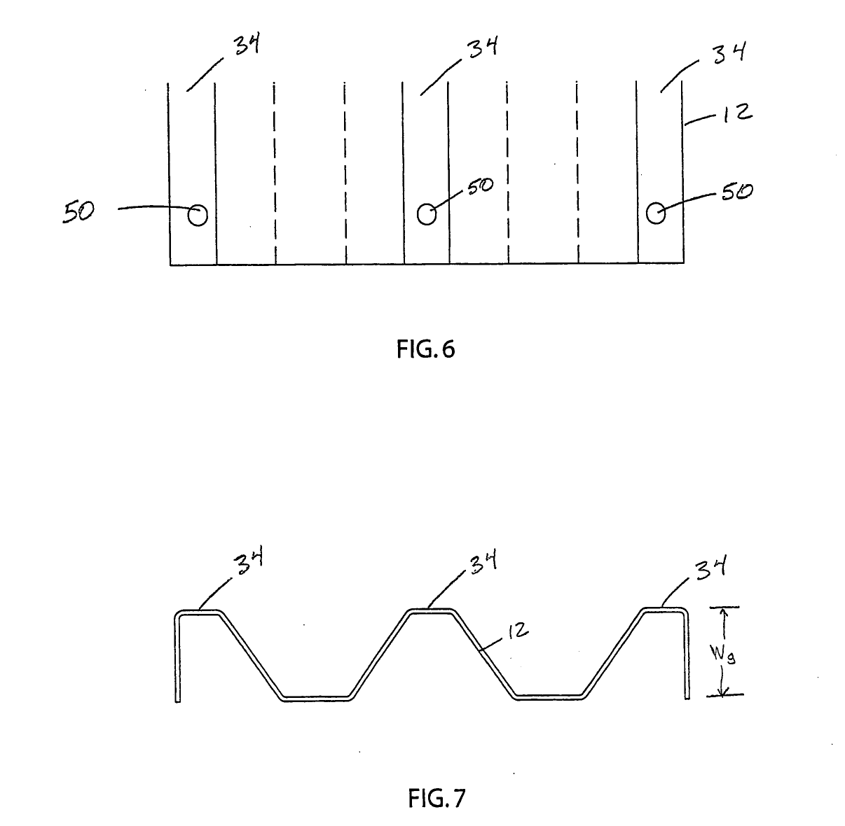

As can be understood in FIGS. 3 and 7, the guardrail mounting bracket 16 has an internal width W_{b} that is slightly greater than the external width W_{g} of the guardrail section 12 such that the guardrail section 12 can be received within the mounting bracket 15. As illustrated in FIG. 6, the guardrail section 12 includes a series of holes 50 formed in the face surfaces 34 such that connectors that pass through the mounting bracket 16 can be received in the holes 50. Thus, the guardrail sections 12 can be secured to the support holes 50 using a series of connectors (not shown).

As illustrated in FIG. 4, each of the mounting brackets 16 is formed from a flat piece of steel material that is bent into the U-shaped configuration shown in FIG. 3. Typically, the mounting bracket 16 is formed from stamped steel to have the required durability for use in the proposed system.

Referring back to FIG. 1, the lower section of guardrail is mounted beneath the upper section of guardrail by using two separate mounting brackets 16 spaced along the face surface 42 of the support post 14. It is contemplated by the inventors that more than two guardrail sections 12 could be utilized within the scope of the present invention.

It is recognized that other equivalents, alternatives, and modifications aside from those expressly stated, are possible and within the scope of the appended claims.

1. A guardrail mounting arrangement, the arrangement comprising:
a support post having a face surface including a plurality of receiving slots formed therein, the receiving slots being aligned in a pair of spaced columns;
at least one mounting bracket having a pair of sidewalls each including a series of depending ears, each of the ears being sized to be received in one of the receiving slots formed on the support post, the pair of sidewalls defining an open interior; and
a guardrail section extending between a first end and a second end, the first end of the guardrail section being sized to be received within the mounting bracket such that the mounting bracket supports the first end of the guardrail section along the support post.

2. The guardrail mounting arrangement of claim 1, further comprising four receiving slots in each of the spaced columns and four depending ears on each of the sidewalls.

3. The guardrail mounting arrangement of claim 11, wherein the mounting bracket is formed from a flat piece of steel material that is bent into a U-shaped configuration.

4. The guardrail mounting arrangement of claim 1, wherein the guardrail section is corrugated.

5. The guardrail mounting arrangement of claim 1, wherein the sidewalls of the mounting bracket and the first end of the guardrail section each comprise at least one hole through which a connector can pass to attach the guardrail section to the mounting bracket.

6. The guardrail mounting arrangement of claim 5, further comprising three holes in each of the sidewalls and mount bracket.

7. A guardrail mounting arrangement, the arrangement comprising:
a support post having a face surface including a plurality of receiving slots formed therein, the receiving slots being aligned in a pair of upper and lower spaced columns;
upper and lower mounting brackets each having a pair of sidewalls, the sidewalls including a series of depending ears, each of the ears being sized to be received in one of the receiving slots formed on the support post, the pair of sidewalls defining an open interior, wherein the upper mounting bracket is attached to the support post along the upper spaced columns and the lower mounting bracket is attached to the support post along the lower spaced columns; and
upper and lower guardrail sections each having an end sized to be received within the respective upper and lower mounting brackets such that the upper and lower support brackets support the ends of the respective upper and lower guard rail sections along the support post;
wherein each of the upper and lower guardrails comprise a corrugated section having a face surface with an aperture formed therein and each of the sidewalls have an aperture formed therein such that when the upper and lower guardrails are supported by the respective upper and lower support brackets, the holes are aligned so that a connector can fit through the respective apertures to attach the upper and lower guard rails to the respective upper and lower mounting brackets.
